(19) United States
(12) Patent Application Publication
(10) Pub. No.: US 2018/0230843 A1
(43) Pub. Date: Aug. 16, 2018

(54) SEALING ELEMENT AND A METHOD OF MANUFACTURING THE SAME

(71) Applicant: ROLLS-ROYCE plc, London (GB)

(72) Inventors: Gary J. WRIGHT, Derby (GB); Simon DONOVAN, Camarthen (GB)

(73) Assignee: ROLLS-ROYCE plc, London (GB)

(21) Appl. No.: 15/874,058

(22) Filed: Jan. 18, 2018

(30) Foreign Application Priority Data
Jan. 19, 2017 (GB) 1700914.3

(51) Int. Cl. F01D 11/12; F01D 25/12

(52) U.S. Cl. CPC F01D 11/125; F01D 25/12; F05D 2250/711; F05D 2230/31; F05D 2260/201; F05D 2220/32

(57) ABSTRACT

An abradable sealing element is positioned radially outwardly of a plurality of aerofoil blades of a gas turbine engine. The abradable sealing element comprises a radially inwardly facing surface region and a plurality of cooling holes.

The radially inwardly facing surface region comprises a wall structure, with the wall structure having one or more radially inwardly projecting walls formed by additive layer, powder fed, laser weld deposition.

Each of the inwardly projecting walls is continuous and defines a plurality of repeating units arranged circumferentially around the radially inwardly facing surface region, each repeating unit is open at a radially inwardly facing side of the sealing element, and each repeating unit comprises a plurality of curved portions forming a multi-lobed profile shape. Each cooling hole is provided in the radially inwardly facing surface region at a position within the multi-lobed profile shape.

### CROSS-REFERENCE TO RELATED APPLICATION

This disclosure claims the benefit of UK Patent Application No. GB 1700914.3, filed on 19 Jan. 2017, which is hereby incorporated herein in its entirety.

### FIELD OF THE DISCLOSURE

The present disclosure relates to a sealing element for positioning radially outwardly of the aerofoil blades of a gas turbine engine, together with a method of manufacturing the same.

### BACKGROUND TO THE DISCLOSURE

In a gas turbine engine, some of the aerofoil blades and in particular the turbine blades are conventionally surrounded by a sealing structure, which may comprise an annular seal or a seal segment ring made up of a plurality of arc shaped seal segments. During operation of the engine, the turbine blades expand and contract as their temperatures vary and centrifugal loads are imposed upon them. As a consequence, it is normal to provide a small clearance between the turbine blade tips and the seal surface, in order to allow for this variation in blade length.

It is known to provide an abradable seal for sealing between the turbine blade tips and the sealing structure. This enables the tips of the turbine blades to wear away the seal to an optimum size and shape without causing damage to the turbine blade tips. Such abradable seals may consist of an open cell foil honeycomb which is brazed in place and subsequently filled with a suitable abradable material, such as a metallic powder. It is also known to directly machine, perhaps by electro discharge machining (EDM), a sealing segment made from an oxidation resistant alloy to form a honeycomb structure that is also filled with a suitable abradable material, such as a metallic powder. In both cases the honeycomb acts as a support for the abradable material. The supporting honeycomb is subsequently partially worn away by the rotating turbine blades, thus forming a seal.

Certain problems are associated with the above sealing structures. The seals may suffer from progressive oxidation attack if the foil material has inadequate oxidation resistance. In addition, problems may be experienced with the brazed joints, and the seals may be difficult to cool.

Further problems may arise when the honeycomb structure has worn and needs to be refurbished. Sealing structures produced by vacuum brazing thin foil honeycomb structures to a sealing segment are conventionally refurbished by machining away the remains of the worn honeycomb material and re-attaching a portion of new honeycomb material using vacuum brazing. The brazing quality may be adequate for low temperature applications, but at elevated temperatures the brazing will lose its integrity and fail, thereby limiting this technique to low temperature applications.

Where abradable portions have been machined from a solid sealing segment it is required to replace the seal segment in its entirety, thereby adding to the overall cost of the refurbishment process.

### STATEMENTS OF DISCLOSURE

According to a first aspect of the present disclosure there is provided an abradable sealing element for positioning radially outwardly of a plurality of aerofoil blades of a gas turbine engine, the abradable sealing element comprising:
a radially inwardly facing surface region; and
a plurality of cooling holes,
   the radially inwardly facing surface region comprising a wall structure, the wall structure having one or more radially inwardly projecting walls formed by additive layer, powder fed, laser weld deposition;
   wherein each of the inwardly projecting walls is continuous and defines a plurality of repeating units arranged circumferentially around the radially inwardly facing surface region, each repeating unit being open at a radially inwardly facing side of the sealing element, each repeating unit comprises a plurality of curved portions forming a multi-lobed profile shape, and each cooling hole is provided in the radially inwardly facing surface region at a position within the multi-lobed profile shape.

By forming each repeating unit with a multi-lobed profile shape, the abradable sealing element has an increased perimetric length of inwardly projecting wall. This in turn increases the degree of abrasion that can be accommodated by the sealing element before maintenance or repair is required.

The multi-lobed profile of each repeating unit also increases the structural rigidity of the sealing element structure, which in turn increases its effectiveness at sealing against the plurality of aerofoil blades.

Optionally, a cooling hole is provided in each of the plurality of multi-lobed profile shapes.

Providing a cooling hole within each of the multi-lobed profile shapes enables a cooling air flow to pass over the walls of the profile shape to keep the walls cool.

The provision of a cooling air flow into the region enclosed by the multi-lobed profile shape prevents the build-up of debris and/or wear particles within the profile shape.

Optionally, a plurality of tubular guard walls is provided in the radially inwardly facing surface region, each guard wall being positioned at a position concentric with a corresponding one of the cooling holes.

The guard wall surrounding each of the cooling holes prevents debris and/or wear particles from accumulating around the cooling holes, and which might otherwise restrict or block the hole.

The tubular geometry of the guard walls corresponds to the cross-sectional profile of the cooling holes. In other words, the guard wall has the same cross-sectional geometry as the cooling hole. This has the effect of moving the exit aperture of a cooling flow through the cooling holes to the radially outward surface of the abradable sealing element.

Optionally, each guard wall is provided with a perforated cover portion at a radially inward end thereof, the perforated cover portion extending completely across the radially inward end.

The perforated cover portion prevents blockage of the cooling hole by blown powder and sinter.

The perforations in the cover portion provide a diffusing action for the cooling flow through the holes during operational use of the sealing element.

Optionally, each guard wall extends radially inwardly from the surface region to a first height.

Each of the guard walls has the same radially inward height as the wall structure, i.e. both the guard walls and the wall structure extend radially inwardly from the surface region to the first height.

This ensures that when the spaces between the wall structure and the guard walls is filled with the abradable material, the cooling holes remain clear, i.e. the guard wall prevents abradable material from entering the cooling holes.

Optionally, the wall structure extends radially inwardly from the surface region to the first height.

By making the guard wall lower than the wall structure, the cooling air flow exhausting from the cooling hole can spill over the edge of the hole and into the centre region of each corresponding multi-lobed shape, even when the aerofoil blades are passing over the radially inwardly surfaces of the wall structure.

Optionally, the walls further form one or more straight line boundaries at one or more edges of the radially inner surface region.

The use of a straight wall boundary enables the wall structure to be more closely packaged into the gas turbine engine. This makes the sealing element more convenient for a user.

Optionally, each of the curved portions has a radius of curvature greater than 0.5 mm.

Forming each of the curved portions with a radius of curvature greater than 0.5 mm prevents debris and/or wear particles from agglomerating within the multi-lobed profile shape and thereby reducing the effectiveness of the abradable layer. A build-up of debris and/or wear particles within the multi-lobed profile shape can result in increased heat generation due to increased friction and reduced cooling air flow.

Optionally, the wall structure extends continuously from a boundary into a central region of the sealing element, around a plurality of concave and convex arcs and returning to the straight line boundary, the sum of the lengths of the concave arcs being substantially equal to the sum of the length of the convex arcs.

Forming the lengths of the concave arcs to be substantially equal to the sum of the length of the convex arcs provides for a substantially symmetrical wall structure geometry. This in turn makes the sealing element more easily packaged within the available space, and maximises the wall length.

Optionally, the wall returns to the boundary adjacent to the point at which the wall leaves the boundary.

This makes the wall structure more compact and space efficient, and hence more convenient for a user.

Optionally, the walls are configured such that all the additive layers of each multi-lobed profile shape can be formed by moving the laser in a closed-circuit weld deposition path, without any reversal of laser direction, from a weld deposition start point to a weld deposition end point.

Forming each of the additive layers making up the wall structure, in a single pass makes the abradable sealing element easier and quicker to manufacture. Forming each additive layer in a single pass also makes the layer more robust and structurally stronger.

Optionally, the repeating units are bounded solely by the continuous wall and the radially inwardly facing surface of the sealing element.

Optionally, a thickness of the walls reduces towards their radially inwardly facing edges.

Tapering a thickness of the walls in a radially outwardly direction makes the walls structurally more rigid and hence less susceptible to damage.

Optionally, the wall structure extends over substantially the whole of the radially inner surface region of the sealing element.

This increases the area of the sealing element over which the aerofoil blades will sweep and hence increases the sealing efficiency of the sealing element.

Optionally, the spaces between adjacent ones of the repeating units, and the spaces between the wall structure and the guard walls, are filled with an abradable material

Filling the spaces between adjacent ones of the repeating units with an abradable material increases the abrasion resistance of the sealing element and hence increase the service life of the sealing element.

Optionally, the radially inwardly facing surface region completely encloses the plurality of aerofoil blades.

In one arrangement of the disclosure, the abradable sealing element is formed in a single piece as a circular ring completely enclosing the plurality of aerofoil blades.

According to a second aspect of the present disclosure there is provided a seal segment ring for a turbine of a gas turbine engine, wherein the seal segment ring comprises a plurality of circumferentially arranged abradable sealing elements according to the first aspect.

In another arrangement of the disclosure, a seal segment ring is formed from two or more abradable sealing elements, each sealing element being formed with a sector shaped geometry. This arrangement enables multiple smaller components to be used to form a seal segment ring.

This arrangement may be more convenient when the seal segment ring has a large diameter. This arrangement also makes repair and/or overhaul easier and quicker fora user.

According to a third aspect of the present disclosure there is provided a gas turbine engine comprising a turbine assembly, the turbine assembly comprising a seal segment ring according to the first aspect.

According to a fourth aspect of the present disclosure there is provided a method of forming an abradable sealing element according to the first aspect, the method comprising the step of:
forming the wall structure at a radially inwardly facing surface region of the abradable sealing element by additive layer, powder fed, laser weld deposition; and
forming a plurality of cooling holes, each cooling hole being provided in the radially inwardly facing surface region at a position within a respective one of the multi-lobed profile shapes.

Optionally, the method further comprises the step of:
inserting a scaffold structure into each of the cooling holes; and
forming a plurality of guard walls in the radially inwardly facing surface region, each guard wall being positioned at a position concentric with one of the corresponding cooling holes.

The use of a scaffold structure provides mechanical support for features such as tubular walls. A scaffold structure is inserted into each of the cooling holes in the surface region and as the blown powder is deposited onto the surface the scaffold maintains the geometry of the guard wall.

Optionally, the method further comprises the step of:
forming a perforated cover portion completely across a radially inward end of the guard wall.

Forming a perforated cover portion over the radially inward end of the guard wall prevents the ingress of blown powder and sinter which might otherwise block the cooling hole and/or the guard wall structure.

Optionally, the method further comprises the step of:
removing the scaffold structure from each of the cooling holes.

The scaffold structure is formed from a material that is burned out during the sinter cycle.

Optionally, all of the additive layers of each curved profile shape are formed by moving the laser in a closed-circuit weld deposition path, without any reversal of laser direction, from a weld deposition start point to a weld deposition end point.

Other aspects of the disclosure provide devices, methods and systems which include and/or implement some or all of the actions described herein. The illustrative aspects of the disclosure are designed to solve one or more of the problems herein described and/or one or more other problems not discussed.

### BRIEF DESCRIPTION OF THE DRAWINGS

There now follows a description of an embodiment of the disclosure, by way of non-limiting example, with reference being made to the accompanying drawings in which:

FIG. 1 shows a schematic part-sectional view of a turbofan gas turbine engine incorporating an abradable sealing element according to an embodiment of the present disclosure;

FIG. 2 shows a perspective view of an abradable sealing element according to the prior art;

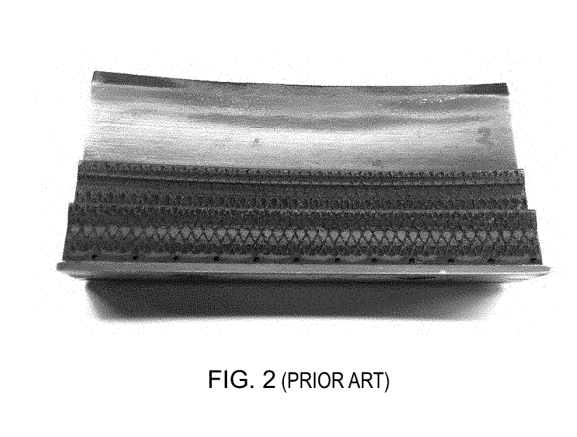

FIG. 3 shows a schematic plan view of a wall structure of the abradable sealing element of FIG. 1; and

FIG. 4 shows a schematic perspective view of the abradable sealing element of FIG. 1.

It is noted that the drawings may not be to scale. The drawings are intended to depict only typical aspects of the disclosure, and therefore should not be considered as limiting the scope of the disclosure. In the drawings, like numbering represents like elements between the drawings.

### DETAILED DESCRIPTION

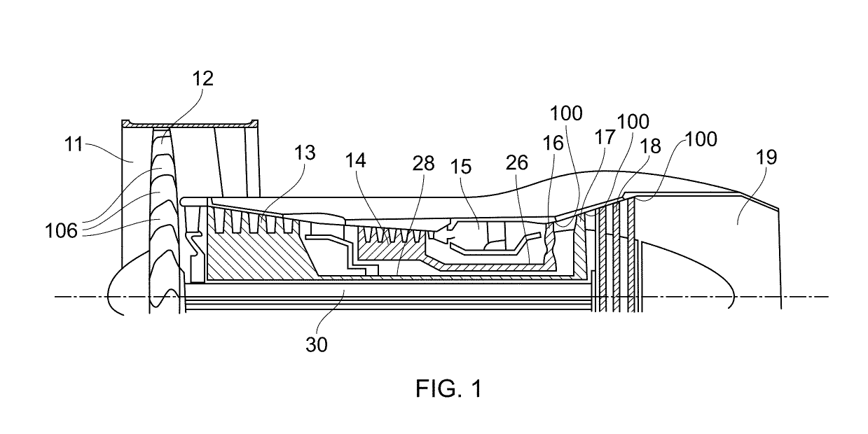

A turbofan gas turbine engine 108, as shown in FIG. 1, comprises in flow series an intake 11, a fan 12, an intermediate pressure compressor 13, a high pressure compressor 14, a combustion chamber 15, a high pressure turbine 16, an intermediate pressure turbine 17, a low pressure turbine 18 and an exhaust 19. The fan assembly 12 comprises a plurality of circumferentially arranged aerofoil blades 106. The high pressure turbine 16 is arranged to drive the high pressure compressor 14 via a first shaft 26. The intermediate pressure turbine 17 is arranged to drive the intermediate pressure compressor 13 via a second shaft 28 and the low pressure turbine 18 is arranged to drive the fan 12 via a third shaft 30. In operation air flows into the intake 11 and is compressed by the fan 12. A first portion of the air flows through, and is compressed by, the intermediate pressure compressor 13 and the high pressure compressor 14 and is supplied to the combustion chamber 15. Fuel is injected into the combustion chamber 15 and is burnt in the air to produce hot exhaust gases which flow through, and drive, the high pressure turbine 16, the intermediate pressure turbine 17 and the low pressure turbine 18. The hot exhaust gases leaving the low pressure turbine 18 flow through the exhaust 19 to provide propulsive thrust. A second portion of the air bypasses the main engine to provide propulsive thrust.

Each of the high pressure turbine 16, the intermediate pressure turbine 17 and the low pressure turbine 18, comprises one or more turbine discs. Each turbine disc comprises a plurality of turbine blades enclosed by an abradable sealing element 100. The abradable sealing element provides a light rubbing seal between the radially distal edges of the turbine blades and the turbine housing.

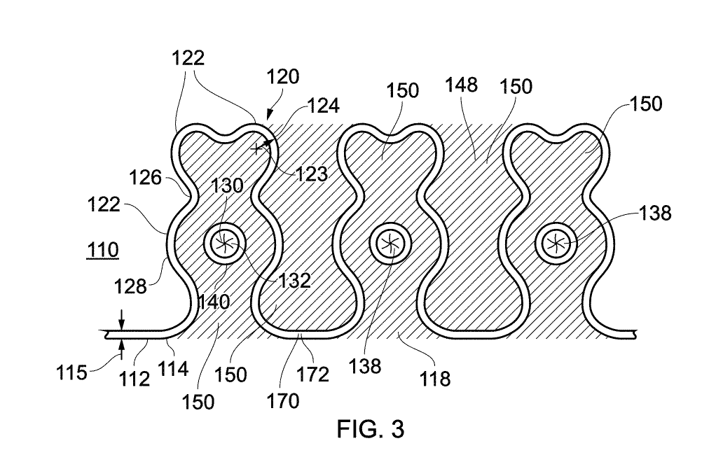

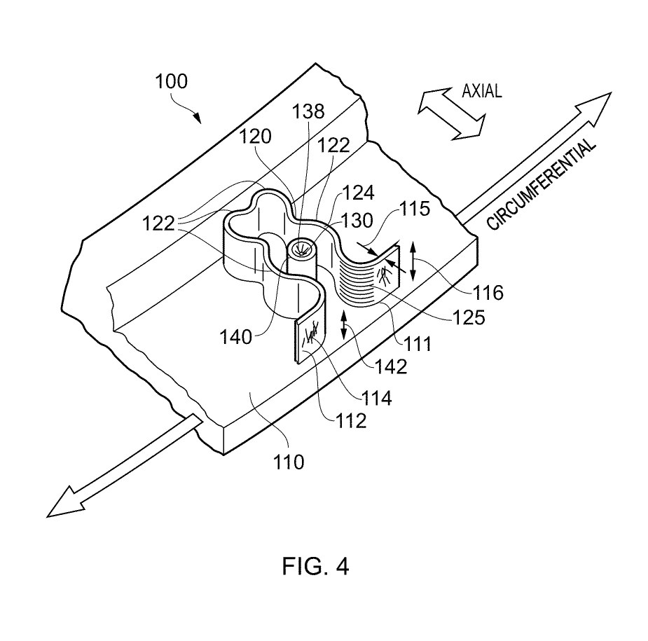

Referring to FIGS. 3 and 4, an abradable sealing element according to an embodiment of the disclosure is designated generally by the reference numeral 100, the holder

The abradable sealing element 100 comprises a radially inwardly facing surface region 110 and a plurality of cooling holes 130.

In the embodiment shown in FIGS. 3 and 4, the abradable sealing element 100 is formed as a sector of a larger circular geometry. In other words, several abradable seal elements 100 are positioned together in a circumferentially contiguous arrangement to form a circular seal segment ring.

In other embodiments of the disclosure the abradable sealing element 100 may be formed a unitary circular component.

The radially inwardly facing surface region 110 comprises a wall structure 112. The wall structure 112 has one or more radially inwardly projecting walls 114. The radially inwardly projecting walls 114 are formed by additive layer, powder fed, laser weld deposition. In other words, the radially inwardly projecting walls 114 are formed from a plurality of individual wall layers 125.

The geometry of the radially inwardly projecting walls 114 is such that each additive layer 125 can be formed by moving the laser in a closed-circuit weld deposition path, without any reversal of laser direction, from a weld deposition start point 170 to a weld deposition end point 172.

Each of the inwardly projecting walls 114 is continuous. Each of the inwardly projecting walls 114 has a wall thickness 115. Each of the inwardly projecting walls 114 has a first height 116 in a direction normal to, and extending from, the radially inwardly facing surface 110. Each of the inwardly projecting walls 114 defines a plurality of repeating units 120 arranged circumferentially around the radially inwardly facing surface region 110.

Each of the repeating units 120 is open at a radially inwardly facing side of the surface region 110. Each repeating unit 120 comprises a plurality of curved portions 122 that together form a multi-lobed profile shape 124.

Each of the curved portions 122 has a radius of curvature 123. In the present arrangement the radius of curvature 123 is greater than 0.5 mm.

In the present embodiment, the plurality of curved portions 122 comprises a plurality of concave arcs 126 and plurality of convex arcs 128. The plurality of curved portions 122 comprises an alternating arrangement of concave arcs 126 and convex arcs 128. In the present arrangement, the sum of the lengths of the concave arcs 126 is substantially equal to the sum of the length of the convex arcs 128.

Each cooling hole 130 is provided in the radially inwardly facing surface region 110 at a position 132 within the multi-lobed profile shape 124. A cooling hole 130 is provided in each of the plurality of multi-lobed profile shapes 124. In another arrangement, a cooling hole 130 may be provided in alternate ones of the plurality of multi-lobed profile shapes 124.

A guard wall 140 is provided in the radially inwardly facing surface region 110 at a position concentric with a corresponding one of the cooling holes 130. In other words, each cooling hole 130 is provided with a corresponding guard wall 140, with each guard wall 140 being concentric with the corresponding cooling hole 130.

Each guard wall 140 has a second height 142 in a direction normal to, and extending from, the radially inwardly facing surface 110. The second height 142 is equal to the first height 116.

At the start of the process of forming the wall structure 112 and the guard walls 140, a scaffold structure 138 is inserted into each one of the cooling holes 130. The use of scaffold structures 138 provides mechanical support for the deposited material. Such scaffold structures 138 may take many different forms. In this arrangement, the scaffold structure 138 takes the form of a skeletal frame structure.

The multi-lobed profile shape 124 is arranged to extend axially across the radially inwardly facing surface region 110 from a straight line boundary 118. In other words, the straight line boundary 118 lies in a plane normal to an axis of the turbine assembly.

In the present embodiment, the spaces 148 between adjacent ones of the repeating units 120 together with the spaces between the spaces between the wall structure and the guard walls are filled with an abradable material 150. This abradable material 150 extends radially inwardly from the radially inwardly facing surface region 110 to the first height 116. In other words, a radially inwardly facing surface of the abradable material 150 is level with the inwardly projecting walls 114.

After the wall structure 112 and guard walls 140 have been formed and the abradable material 150 deposited, the sealing element 100 is sintered. During the sinter process, the scaffold structure 138 is burned out of the internal volume of the guard wall 140.

Except where mutually exclusive, any of the features may be employed separately or in combination with any other features and the disclosure extends to and includes all combinations and sub-combinations of one or more features described herein.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person of skill in the art are included within the scope of the disclosure as defined by the accompanying claims.

What is claimed is:

1. An abradable sealing element for positioning radially outwardly of a plurality of aerofoil blades of a gas turbine engine, the abradable sealing element comprising:
a radially inwardly facing surface region; and
a plurality of cooling holes,
the radially inwardly facing surface region comprising a wall structure, the wall structure having one or more radially inwardly projecting walls formed by additive layer, powder fed, laser weld deposition;
wherein each of the inwardly projecting walls is continuous and defines a plurality of repeating units arranged circumferentially around the radially inwardly facing surface region, each repeating unit being open at a radially inwardly facing side of the sealing element, each repeating unit comprises a plurality of curved portions forming a multi-lobed profile shape, and each cooling hole is provided in the radially inwardly facing surface region at a position within the multi-lobed profile shape.

2. The abradable sealing element as claimed in claim 1, wherein a cooling hole is provided in each of the plurality of multi-lobed profile shapes.

3. The abradable sealing element as claimed in claim 1, wherein a plurality of tubular guard walls is provided in the radially inwardly facing surface region, each guard wall being positioned at a position concentric with a corresponding one of the or each cooling holes.

4. The abradable sealing element as claimed in claim 3, wherein each guard wall is provided with a perforated cover portion at a radially inward end thereof, the perforated cover portion extending completely across the radially inward end.

5. The abradable sealing element as claimed in claim 3, wherein each guard wall extends radially inwardly from the surface region to a first height.

6. The abradable sealing element as claimed in claim 5, wherein the wall structure extends radially inwardly from the surface region to the first height.

7. The abradable sealing element as claimed in claim 1, wherein the walls further form one or more straight line boundaries at one or more edges of the radially inner surface region.

8. The abradable sealing element as claimed in claim 1, wherein each of the curved portions has a radius of curvature greater than 0.5 mm.

9. The abradable sealing element as claimed in claim 1, wherein the wall structure extends continuously from a boundary into a central region of the sealing element, around a plurality of concave and convex arcs and returning to the straight line boundary, the sum of the lengths of the concave arcs being substantially equal to the sum of the length of the convex arcs.

10. The abradable sealing element as claimed in claim 9, wherein the wall returns to the boundary adjacent to the point at which the wall leaves the boundary.

11. The abradable sealing element as claimed in claim 1, wherein the walls are configured such that all the additive layers of each multi-lobed profile shape can be formed by moving the laser in a closed-circuit weld deposition path, without any reversal of laser direction, from a weld deposition start point to a weld deposition end point.

12. The abradable sealing element as claimed in claim 1, wherein the repeating units are bounded solely by the continuous wall and the radially inwardly facing surface of the sealing element.

13. The abradable sealing element as claimed in claim 1, wherein a thickness of the walls reduces towards their radially inwardly facing edges.

14. The abradable sealing element as claimed in claim 1, wherein the spaces between adjacent ones of the repeating units, and the spaces between the wall structure and the guard walls, are filled with an abradable material.

15. A seal segment ring for a turbine of a gas turbine engine, wherein the seal segment ring comprises a plurality of circumferentially arranged abradable sealing elements as claimed in claim 1.

16. A method of forming an abradable sealing element, the method comprising the step of:
forming the wall structure at a radially inwardly facing surface region of the abradable sealing element by additive layer, powder fed, laser weld deposition; and
forming a plurality of cooling holes, each cooling hole being provided in the radially inwardly facing surface region at a position within a respective one of the multi-lobed profile shapes.

17. The method as claimed in claim 16, the method further comprising the step of:
inserting a scaffold structure into each of the cooling holes; and
forming a plurality of guard walls in the radially inwardly facing surface region, each guard wall being positioned at a position concentric with a corresponding one of the cooling holes, and each guard wall being formed around a corresponding one of the scaffold structures.

18. The method as claimed in claim 17, the method further comprising the step of:
forming a perforated cover portion completely across a radially inward end of the guard wall.

19. The method as claimed in claim 18, the method further comprising the step of:
removing the scaffold structure from each of the cooling holes.

20. The method as claimed in claim 16, wherein all of the additive layers of each curved profile shape are formed by moving the laser in a closed-circuit weld deposition path, without any reversal of laser direction, from a weld deposition start point to a weld deposition end point.
